(19) United States
(12) Patent Application Publication
(10) Pub. No.: US 2026/0201654 A1
(43) Pub. Date: Jul. 16, 2026

(54) STABILIZING ASSEMBLY AND METHOD FOR STABILIZING A TRACK

(71) Applicant: PLASSER & THEURER EXPORT VON BAHNBAUMASCHINEN GESELLSCHAFT M.B.H., Wien (AT)

(72) Inventors: Florian AUER, Wien (AT); Bernhard ANTONY, Stockerau (AT); Dietmar ADAM, Mödling (AT); Johannes PISTROL, Wien (AT); Manuel DAFERT, Wien (AT); Fritz KOPF, Wien (AT); Wolfgang ANDROSCH, Wels (AT)

(21) Appl. No.: 19/132,069

(22) PCT Filed: Nov. 9, 2023
(86) PCT No.: PCT/EP2023/081260

§ 371 Date: May 22, 2025

(30) Foreign Application Priority Data
Nov. 22, 2022 (AT) A50880/2022

(51) Int. Cl. E01B 27/16

(52) U.S. Cl. CPC E01B 27/16

(57) ABSTRACT

A stabilizing unit for stabilizing a track has a vibration generator with rotating shafts that are orientated parallel to one another and have unbalanced masses for generating an impact force with an adjustable direction. Flange wheels and pressure rollers transmit the impact force onto a track panel, that has sleepers and rails secured thereon, of the track to be stabilized. Each flange wheel is rotatably mounted about a wheel axle and has a running surface with a wheel diameter. The rotating shafts are arranged to generate the impact force in a horizontal effective plane such that the horizontal effective plane of the impact force lies no more than 300 mm, in particular no more than 260 mm, above a rolling plane of the flange wheels. The sunken horizontal effective plane prevents interfering tilting torques during a stabilization process.

### FIELD OF TECHNOLOGY

The invention relates to a stabilizing unit for stabilizing a track, with a vibration generator comprising rotating shafts aligned parallel to one another with unbalance masses for generating an impact force with adjustable direction, and with flanged wheels and pressing rollers for transmitting the impact force to a track panel of the track to be stabilized, consisting of sleepers and rails fixed thereon, with each flanged wheel being mounted to rotate about a wheel axis and having a running tread with a wheel diameter. The invention further relates to a rail vehicle with one such stabilizing unit and a method for operating the rail vehicle.

### PRIOR ART

A ballasted track is continuously stressed by railway traffic and by environmental influences. For example, the position of a track panel in the ballast bed changes. The ballast bed itself becomes fouled over time due to abrasion and due to foreign matter introduced. Maintenance measures such as tamping processes or cleaning processes eliminate these defects. However, this results in a temporary loosening of the ballast bed. Even after optimal compaction by means of a tamping unit, subsequent settlements can occur. A machine is used to stabilize the track to control such settlements.

The machine can be moved along the track and comprises a stabilizing unit that is clamped onto the rails of the track by means of unit rollers. A vibration generator arranged on the stabilizing unit generates vibrations that are transmitted to the track panel. The design and dimensions of the vibration generator determine an impact force that acts on the track with the vibration frequency. The stabilizing unit is supported against a machine frame to generate a static imposed load. The transmitted vibrations cause the grains in the grain structure of the ballast bed to become mobile, allowing them to be shifted and rearrange themselves with higher compactness. This optimized ballast compaction results in an increase in the load carrying capacity and the lateral track resistance of the track.

AT 16604 U1 discloses an exemplary stabilizing unit with variable impact force. Here, the vibration generator comprises a plurality of rotating unbalance masses that are arranged on shafts aligned in parallel. The unbalance masses are driven with a phase shift that can be variably adjusted in relation to one other. Depending on the arrangement of the unbalanced masses, a changed phase shift changes both the direction and the strength of the impact force.

### PRESENTATION OF THE INVENTION

The object of the invention is to improve a stabilizing unit of the kind mentioned above in such a way that the impact force acts on the track in an optimized manner. Furthermore, it is an object of the invention to indicate a rail vehicle which uses the extended application possibilities of the improved stabilizing unit. Additionally, an advantageous method for operating such a rail vehicle is to be indicated.

According to the invention, these objects are achieved by the features of independent claims 1, 12, and 14. Dependent claims indicate advantageous embodiments of the invention.

With the new stabilizing unit, the rotating shafts are arranged to generate the impact force in a horizontal plane of action in such a way that the horizontal plane of action of the impact force is no more than 300 millimetres, in particular no more than 260 millimetres, above a rolling plane of the flanged wheels. The low-lying horizontal plane of action prevents disruptive tilting moments during a stabilization process. In use, the rolling plane of the flanged wheels corresponds to a plane of the track to be stabilized that is spanned by the tops of rails. If the horizontal impact force is at most 260 millimetres above this rolling plane or top of rail plane, resting of the sleepers on a saddle-shaped surface can be safely excluded. This also applies to a maximum value of 300 millimetres, with a larger free space being available below the stabilizing unit for the arrangement of a chord measuring system or an optical measuring system.

Advantageously, the horizontal plane of action lies less than half a wheel diameter above a horizontal plane passing through the respective wheel axis. The vibration generator is arranged there at a correspondingly low level, with the wheel diameters being sufficiently large so that no damaging pressure peaks occur on the rail surfaces. The flanged wheels are placed at a distance so far apart from each other that there is a construction space in between for the vibration generator. This also applies to the elements of a spreading axle, which press the flanged wheels against the rails during operation. In conventional stabilizing units, the vibration generator is always arranged in an area above the flanged wheels, from which a high horizontal plane of action of the impact force results. If severe, the resulting tilting moments can lead to resting of the sleepers on the saddle-shaped surface of a ballast layer in the middle of the track.

Advantageously, at least two rotating shafts and/or unbalance masses are coupled to gearbox elements and driven by a common drive. In this way, the common drive with an optimized control can be used to drive all rotating shafts or unbalance masses. The type of coupling determines how the centrifugal forces caused by the unbalance masses produce the resulting impact force. Preferably, the centrifugal forces increase in a desired plane of action, whereas the centrifugal forces in other plane of actions cancel each other out.

In a further improvement, at least one unbalance mass is mounted to rotate on each rotating shaft. Compared to an unbalance mass fixed on the rotating shaft, this unbalance mass can be driven with a changed angular position, rotational speed, and direction of rotation. This allows the direction and amount of a resulting centrifugal force to be adjusted.

Preferably, at least one unbalance mass is coupled to the assigned rotating shaft by means of a coupling element that is dependent on the direction of rotation in such a way that when the direction of rotation changes, the unbalance mass is rotated relative to the rotating shaft, in particular by 180°. Together with an unbalance mass arranged permanently on the rotating shaft, there are two different resulting centrifugal forces as a function of the direction of rotation. This means that the stabilizing unit can be operated with different impact forces at the same vibration frequency.

In a further development of this variant, the at least one unbalance mass is coupled to the assigned rotating shaft by means of a centrifugal-force locking mechanism. This centrifugal-force locking mechanism locks the unbalance mass on the assigned rotating shaft as soon as a specified speed is exceeded. This ensures that there is no unwanted reversal of the unbalance mass during ongoing operation.

An advantageous design with a low centre of gravity comprises a central rotating shaft parallel to a unit longitudinal direction and a lateral rotating shaft to the left and right thereof. This results in a symmetrical design with different drive variants, with disruptive tilting moments being largely prevented during operation.

If this design is improved, the unbalance masses assigned to the central rotating shaft have an unbalance twice as large as the unbalance masses assigned to the respective lateral rotating shaft. In this way, the impact force can be adjusted without discrete steps from zero.

A further improvement provides for directly driven unbalance masses to be coupled to a common drive, with indirectly driven unbalance masses being coupled to the directly driven unbalance masses via a planetary gearbox. The resulting joint centrifugal force effect of all unbalance masses can be adjusted via the planetary gearbox.

Here, a cage of the planetary gearbox is favourably mounted to rotate and coupled to a rotation drive. The cage can be set in rotation by means of the rotation drive, which changes the relative angular velocity of the directly driven unbalance masses to the indirectly driven unbalance masses.

An additional preferred further development of the stabilizing unit comprises an acceleration sensor for recording an acceleration caused by means of the vibration generator. Either the movements of the stabilizing unit or of the track panel set in vibration are recorded in order to draw conclusions about the reaction force of the track panel.

The rail vehicle according to the invention comprises a machine frame, which is movable on rail running gears on a track, and at least two of the stabilizing units described above, with a front stabilizing unit with first height setting drives being fastened to the machine frame and with a rear stabilizing unit with second height setting drives being fastened to the machine frame. In this way, the stabilizing units can be operated independently of each other with different imposed loads and different impact forces.

Advantageously, the vibration generators and the height setting drives are actuated by means of a common control device, with the control device being set up for separate actuation of the respective vibration generator and the respective height setting drive. The two stabilizing units can be operated in a coordinated manner by means of the common control unit. For example, synchronized vibrations are applied to the track panel.

In the method according to the invention for operating the rail vehicle, a forward movement takes place along the track to be stabilized, with the front stabilizing unit being operated with a vertical impact force and with the rear stabilizing unit being operated with a horizontal impact force. This operating mode is used to simulate travel over the track of a rail vehicle in normal operation, because a take-off wave preceding the rail vehicle is usually followed by a sinusoidal course of the rail running gears of the rail vehicle. The rail vehicle according to the invention controls these processes and, in this way, leaves a particularly sustainably stabilized track.

A further development of the method uses an acceleration sensor of the front stabilizing unit, by means of which vertical accelerations are recorded in order to derive a reaction force progression of the track panel. Specifically, the corresponding reaction force is determined using the measured force-proportional acceleration and the known forces from the dynamic excitation.

### BRIEF DESCRIPTION OF THE DRAWINGS

The invention is explained below in an exemplary manner with reference to the attached figures. A schematic representation is shown:

FIG. 1 Rail vehicle with stabilizing unit

FIG. 2 Track cross-section with stabilizing unit

FIG. 3 Flanged wheel and pressing roller in contact with the rail

FIG. 4 Top view and cross-section of a stabilizing unit with three mechanically coupled rotating shafts

FIG. 5 Changing the direction of rotation of the rotating shafts of the stabilizing unit according to FIG. 4

FIG. 6 Stabilizing unit according to FIG. 4 with maximum horizontal force excitation

FIG. 7 Stabilizing unit according to FIG. 4 with maximum vertical force excitation

FIG. 8 Stabilizing unit according to FIG. 4 during rotation of the planetary gearbox

FIG. 9 Stabilizing unit according to FIG. 4 with differently set impact force

FIG. 10 Impact force curves with different drive conditions of the stabilizing unit according to FIG. 4

FIG. 11 Reduction factor of a vibration amplitude of the stabilizing unit according to FIG. 4

FIG. 12 Work diagram of a track panel area set in vibration

FIG. 13 Drive shaft with unbalance masses

FIG. 14 Unbalance mass with centrifugal-force locking mechanism

### DESCRIPTION OF THE EMBODIMENTS

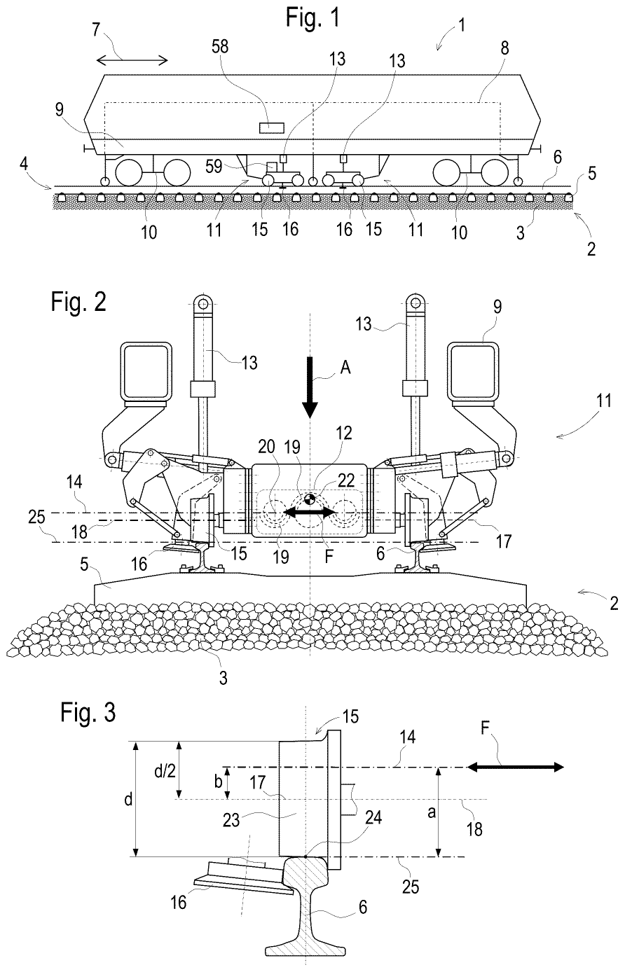

A rail vehicle 1 shown in FIG. 1 is a so-called dynamic track stabilizer for stabilizing a ballasted track 2 following a tamping process. The track 2 comprises a ballast bed 3 in which a track panel 4, consisting of sleepers 5 and rails 6 fastened thereto, is mounted. During continuous forward travel of the rail vehicle 1 in a longitudinal direction 7, the track panel 4 is set in vibration and pressed into the ballast bed 3. This targeted settlement of the track panel 4 is recorded by means of a chord measuring system 8 or by means of optical measuring devices. The exemplary rail vehicle 1 comprises a machine frame 9, supported on rail running gears 10, that can be moved on the track 2 to be stabilized. Two stabilizing units 11 are movably connected to the machine frame 9. In other machines, only a single stabilizing unit 11 is arranged.

FIG. 2 shows a cross-section of the track 2 with the stabilizing unit 11 during a stabilizing process. The stabilizing unit 11 comprises two independent main components, namely a vibration generator 12 and a pair of height setting drives 13 (imposed-load hydraulic cylinders). The vibration generator 12 generates an impact force F in a plane of action 14 alternately in two opposite directions, which causes the stabilizing unit 11 to vibrate. Preferably, the impact force F acts in a horizontal plane. This horizontal plane of action 14 is of essential importance for the present invention. For extended operation of the stabilizing unit 11, however, an effect of the impact force F in a vertical direction also plays a role. The plane of action 14 is then a vertical plane.

Flanged wheels 15 and pressing rollers 16 transmit the vibrations to the track panel 4. Each flanged wheel 15 is mounted to rotate about a wheel axis 17 and is guided along an inner edge of the rail. The wheel axes 17 lie in a common horizontal plane 18. The pressing rollers 16 are pressed against the rails 6 from the outside. An imposed load A, which can be regulated without discrete steps, is applied by means of the height setting drives 13.

Advantageously, the stabilizing unit 11 comprises a self-supporting centre section with the vibration generator 12. The vibration generator 12 comprises unbalance masses 19, which are mounted on rotating shafts 20. Viewed in the longitudinal direction of the track, a lateral frame is connected to the centre section on each side. The centre section is connected to the respective lateral frame by means of threaded connections on a circumferential flange, for example. The flanged wheels 15 and the pressing rollers 16 are mounted exclusively on the assigned lateral frame. To realize a spreading axle 21, the flanged wheels 15 assigned to one of the lateral frames are each coupled to a hydraulic drive to effect a displacement along the assigned wheel axis 17, for example. There is no common through shaft for the front or the rear flanged wheels 15. The lack of a through shaft creates space for the low arrangement of the centre section. The result is a low centre of gravity 22 of the entire stabilizing unit 11 and the low plane of action 14 of the vibration generator 12. Preferably, the centre of gravity 22 lies in the horizontal plane of action 14.

Each flanged wheel 15 has a wheel diameter d, which is measured on a running tread 23. In use, the running treads 23 of the flanged wheels 15 are in contact with tops of rails 24 of the rails 6. The top of rail 24 here is the highest line on a rail head. A lower and an upper tangential plane are in contact with all running treads 23 of the flanged wheels 15. The lower tangential plane forms a rolling plane 25, in which the contact points between the running treads 23 of the flanged wheels 15 and the tops of rails 24 are located during use. According to the invention, the vibration generator 12 is arranged so low that a vertical distance a between the horizontal plane of action 14 of the impact force F and the rolling plane 25 is at most 300 millimetres, in particular at most 260 millimetres. Very good results were achieved in tests with the vertical distance a=250 mm. Even with unfavourable compaction conditions of the ballast, there was no resting of the sleepers on a saddled-shaped surface.

Advantageously, the horizontal plane of action 14 is less than half a wheel diameter d/2 of the respective flanged wheel 15 above the horizontal plane 18 passing through the respective wheel axis 17. The upper tangential plane of the running treads 23 forms a boundary plane below which the horizontal plane of action 14 lies. If the horizontal plane of action 14 lies above the wheel axes 17, a further vertical distance b between this plane of action 14 and the horizontal plane 18 is less than half the wheel diameter d/2 of the respective flanged wheel 15. In any case, this characteristic is fulfilled if the horizontal plane of action 14 is below the wheel axes 17. This results in two advantages. On the one hand, the horizontal plane of action 14 lies low enough and, on the other hand, the wheel diameters d of the flanged wheels 15 are large enough so that no damaging pressure peaks occur on the rail surfaces.

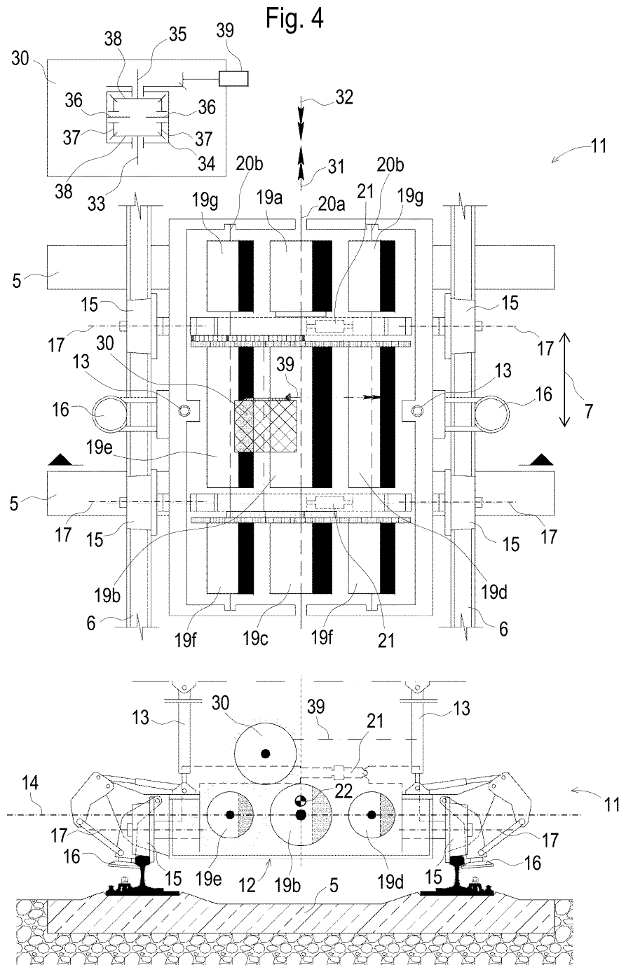

An advantageous embodiment of the vibration generator 12 with reduced construction height is explained with reference to FIGS. 4-11. To achieve a low-lying force excitation, cylindrically shaped unbalance masses 19 are arranged, which rotate about axes aligned in a longitudinal direction 7. The unbalance masses 19 are divided into three groups in the axial direction in order to enable an amplitude, adjustable without discrete steps, of the effective impact force F. In the example shown, most of the unbalance masses 19a, 19b, 19c, 19d, 19e are mounted to rotate freely on a driven centre rotating shaft (drive shaft) 20a or on coupled lateral rotating shafts (auxiliary shafts) 20b. Other unbalance masses 19f, 19g are permanently connected to the assigned rotating shaft 20a, 20b.

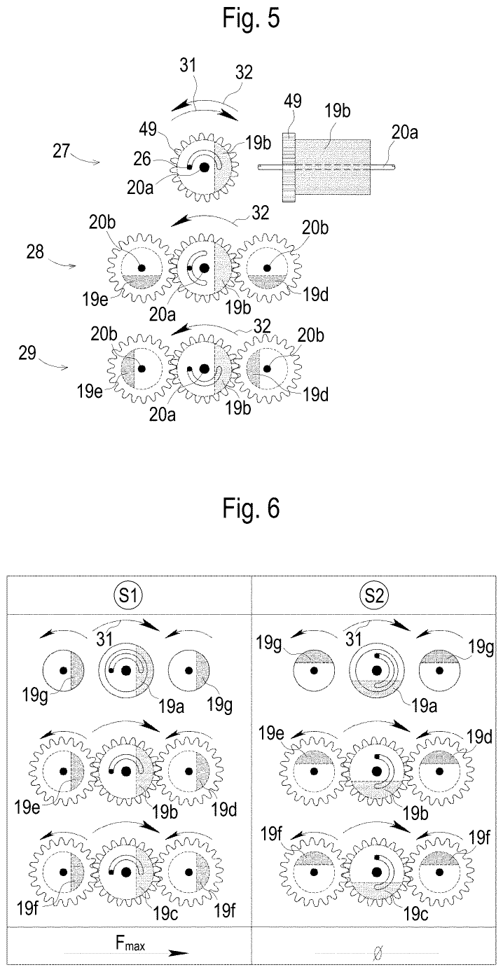

The unbalance masses 19a, 19b, 19c, which are mounted on the drive shaft 20a, have coupling elements 26 which are dependent on the direction of rotation and through which they are connected to a respective drive mechanism. One such drive mechanism is, for example, a cylinder wheel permanently mounted on the drive shaft 20a with a corresponding recess for a reversing pin. By changing the direction of rotation of the drive shaft 20a, the unbalance masses 19d, 19e, 19f, 19g on the auxiliary shafts 20b are rotated by 180° relative to an initial position, while the unbalance masses 19a, 19b, 19c on the drive shaft 20a retain their position. This principle is illustrated in FIG. 5 in three chronologically successive phases 27, 28, 29. In the first phase 27, the unbalance masses 19a-19g are in an initial position for horizontal force excitation, with only one unbalance mass 19b of the central group being shown. All unbalance masses 19a-19g point to the right. The second phase 28 shows the reversal process, and the third phase 29 shows the unbalance position for vertical force excitation.

The unbalance masses 19b, 19d, 19e of the central group have twice the unbalance (product of masses and eccentricity, U=m·e) compared to the unbalance masses 19a, 19c, 19f, 19g of the two edge groups. In addition, an unbalance mass 19a, 19b, 19c of the drive shaft 20a has twice the unbalance as an unbalance mass 19a, 19c, 19f, 19g of the auxiliary shaft 20b of the associated group. For example, the unbalance masses 19a, 19b, 19c have twice the unbalance of the unbalance masses 19d, 19e, 19f, 19g, with the unbalance mass 19d having the same unbalance as the unbalance mass 19e, and the unbalance mass 19f has the same unbalance as the unbalance mass 19g. This arrangement makes a vibration generator 12 with impact force amplitude, adjustable without discrete steps, of the entire system possible, with the centrifugal forces cancelling each other out in one direction.

The unbalance masses 19a-19g are driven by the drive shaft 20a and a planetary gearbox 30. FIG. 4 shows a rotational movement 31 of the drive shaft 20a for horizontal excitation and a rotational movement 32 of the drive shaft 20a for vertical excitation. The rotational movement 31, 32 of the drive shaft 20a is transmitted directly to the unbalance masses 19a, 19c on the drive shaft 20a. Subsequently, the rotational movement of the unbalance mass 19c is transmitted to the adjacent unbalance masses 19f via cylinder wheels, which also drives the unbalance masses 19g rigidly connected to the respective auxiliary shaft 20b. In addition, the rotational movement is further transmitted to a gearbox input shaft 33 of the planetary gearbox 30 via a cylinder wheel on the unbalance masses 19c of the drive shaft 20a. In normal operation, a differential cage 34 of the planetary gearbox 30 is at rest, which transmits a counter-rotating rotational movement at the same rotational speed to the unbalance mass 19e of the auxiliary shaft 20b via a gearbox output shaft 35. The other unbalance masses 19b, 19d of the central group are driven via a coupling with this unbalance mass 19e.

FIG. 4 shows in the topmost image the differential cage 34 with differential bolts 36, equalizing bevel gears 37, and axle bevel gears 38. The top view of the unit 11 is shown in the centre image, with a sectional line through the central group of unbalance masses 19b, 19d, 19e resulting in the cross-section of the unit 11 in the bottommost image.

FIG. 6 shows the system of unbalance masses 19a-19g for maximum possible horizontal force excitation. On the left, an unbalance position S1 is shown with the maximum horizontal impact force Fₘₐₓ. On the right, the system is further rotated by an angle of rotation [symbol] =90° in an unbalance position S2, with the resulting excitation force Fₑᵣᵣ being zero.

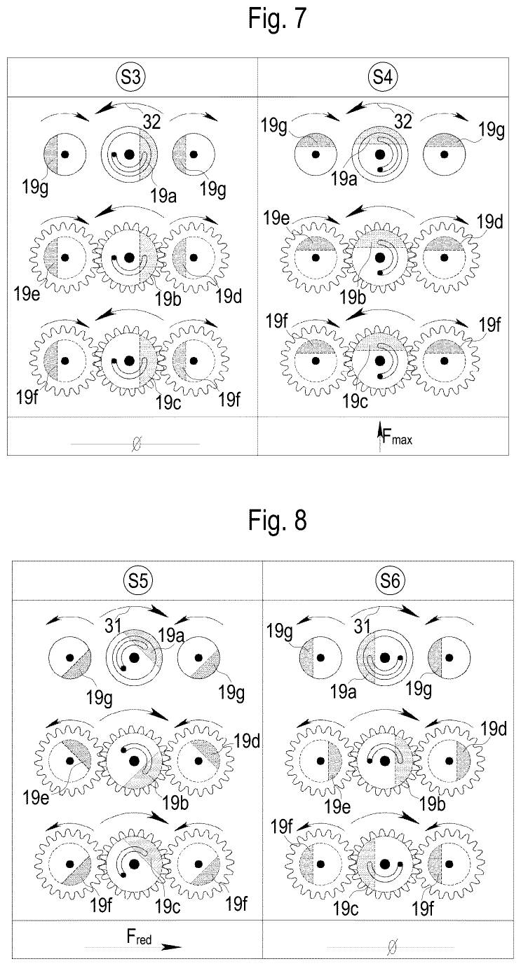

FIG. 7 shows the mode of operation of the system of unbalance masses 19a-19g for maximum possible vertical force excitation. A left unbalance position S3 shows the system with the resulting excitation force Fₑᵣᵣ equal to zero. On the right, the system is further rotated by an angle of rotation [symbol] =90° in an unbalance position S4, with the resulting excitation force Fₑᵣᵣ being zero.

FIG. 8 shows two unbalance positions S5, S6 for the system of unbalance masses 19a-19g when the planetary gearbox 30 rotates. On the left, an unbalance position S5 is shown for a resulting angular difference of 90° between the unbalance masses 19a, 19g and 19c, 19f of the edge groups and the unbalance masses 19b, 19d, 19e of the central group, and on the right, an unbalance position S6 is shown for a resulting angular difference between the unbalance masses 19a, 19g and 19c, 19f of the edge groups and the unbalance masses 19b, 19d, 19e of the central group of 180° (non-excited operation, idling).

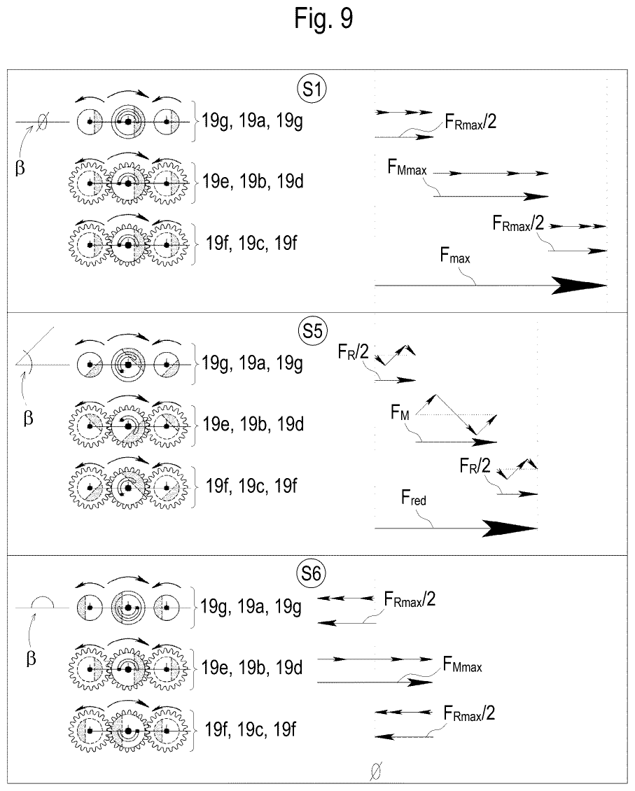

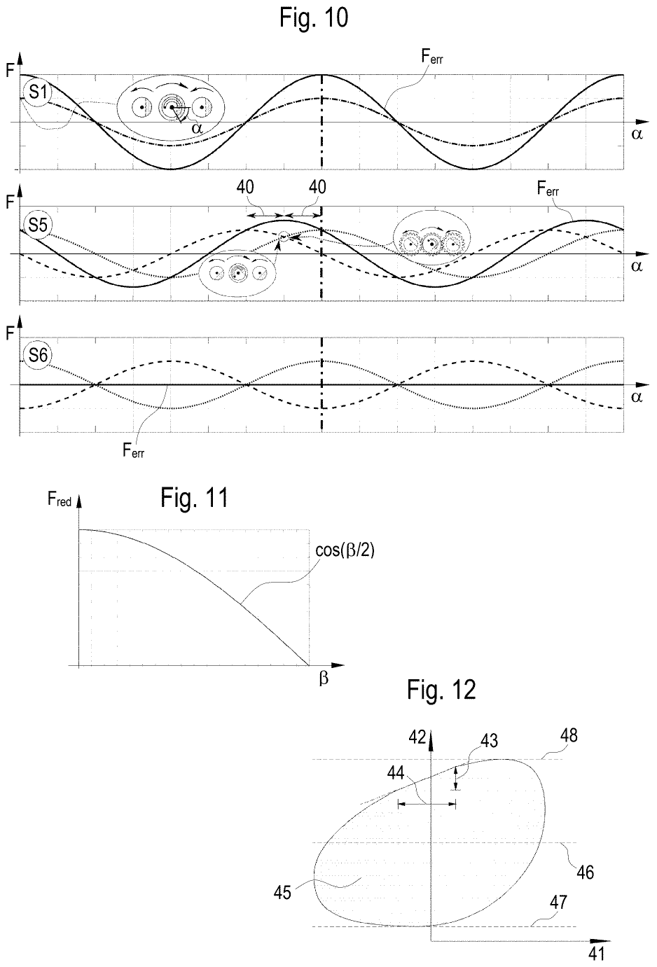

In order to reduce the amplitude of the effective impact force F of the system, the unbalance masses 19b, 19d, 19e of the central group are rotated relative to the other unbalance masses 19a, 19c, 19f, 19g, so that the excitation forces F_{M} of the central group are reduced or equalized when superposed with the excitation forces F_{R} of the edge groups, depending on adjustment (FIG. 9 and FIG. 10). For this purpose, the differential cage 34 of the planetary gearbox 30 is rotated at the angular velocity [symbol] _{D} during ongoing operation via a rotational drive 39 coupled to the differential cage 34. With the known angular velocity [symbol] ₁ Of the gearbox input shaft 33, the angular velocity [symbol] ₂ of the gearbox output shaft 35 can be determined using the Willis equation when the planetary gearbox 30 rotates in the opposite direction to the direction of rotation of the gearbox input shaft 33:

$${ω}_{2} = \frac{1}{{i}_{0}} \cdot ( {ω}_{1} - {ω}_{D} \cdot ( 1 - {i}_{0} ) )$$

For differential gearboxes, the standard gear ratio i₀=−1 can be assumed:

$${ω}_{2} = 2 \cdot {ω}_{D} - {ω}_{1}$$

FIG. 9 shows the system of unbalance masses 19a-19g with the three unbalance positions S1, S5, and S6 from FIGS. 6-8. In the upper image, an angle of difference [symbol] between the edge groups and the central group is zero. This angle of difference [symbol] is 90° in the central image and 180° in the lower image. To the right of the groups of unbalance masses 19a-19g, polygons of forces of the respective excitation forces F_{E} and the respective resulting excitation force Fₑᵣᵣ are shown.

In normal operation, the differential cage 34 is at rest and [symbol] _{D}=0, which means that [symbol] ₂=−1. The gearbox output shaft 35 and the gearbox input shaft 33 then have the same angular velocity but an opposite direction of rotation. When the planetary gearbox 30 rotates, the gearbox output shaft 35 moves faster than the gearbox input shaft 33, with the difference corresponding to twice the angular velocity [symbol] _{D} of the rotating differential cage 34. A rotation between the unbalance masses 19b, 19d, 19e of the central group and the unbalance masses 19a, 19c, 19f, 19g of the edge groups results from the transmission between the shafts 33, 35 of the planetary gearbox 30 and the corresponding unbalance masses 19c, 19e. If the transmission ratio between the shafts 33, 35 of the planetary gearbox 30 and the unbalance masses 19c, 19e is, for example, i=−1 (opposite direction of rotation at the same angular velocity), a rotation (and subsequent fixing) of the differential cage 34 by an angle [symbol] /2 results in an angular difference of [symbol] between the unbalance masses 19b, 19d, 19e of the central group and the unbalance masses 19a, 19c, 19f, 19g of the edge groups. This angular difference [symbol] (phase shift) results in a reduced amplitude of the effective horizontal impact force F of the system in horizontal operation or of the effective vertical impact force F in vertical operation.

The excitation force F_{E} (centrifugal force) of a single unbalance mass 19 results from the product of mass m, eccentricity e, and the square of the angular velocity [symbol] _{U} in the centre of rotation:

$${F}_{E} = m \cdot e \cdot {ω}_{U}^{2}$$

In horizontal operation, any vertical components of the respective unbalance mass groups cancel each other out (e.g. the vertical components of the unbalance masses 19a and 19g cancel each other out), which precisely achieves the maximum excitation force F_{Rmax}, F_{Mmax} of an unbalance mass group when all unbalance masses 19a-19g of the respective group are either horizontal or vertical. Without rotating the unbalance mass groups towards each other (angular difference [symbol] =0, unbalance mass position S1 in FIG. 6 on the left and S4 in FIG. 7 on the right), the excitation forces F_{E} of the unbalance masses 19a, 19g and 19c, 19f of the edge groups and the unbalance masses 19b, 19d, 19e of the central group add up completely, with the excitation force F_{M} of the central group having the same magnitude as the excitation force F_{R} of the two synchronously running edge groups. In this condition, the system operates with the maximum resulting impact force Fₘₐₓ (maximum possible impact force amplitude).

If the unbalance masses 19a-19g are rotated relative to each other, the maximum excitation forces F_{Rmax}, F_{Mmax} cannot be completely superimposed at any time (FIG. 9 and FIG. 10), and a reduced impact force F_{red} of the system occurs. Due to the rotation of the unbalance masses 19a-19g towards each other, the vibration generated by the central group, for example, precedes the vibration generated by the edge groups (phase shift 40). This effect is illustrated in FIG. 10, with the vibrations of the central group and the two synchronously running edge groups being shown for two complete rotations of the unbalance masses 19a-19g, starting from the horizontal position of the edge group unbalance masses 19a, 19c, 19f, 19g.

All three diagrams in FIG. 10 show curves of the summed excitation force F_{R} of the edge groups and the excitation force F_{M} of the central group as well as the resulting excitation force Fₑᵣᵣ over an angle of rotation [symbol] , with the initial position corresponding to the three unbalance positions S1, S5, and S6 in FIG. 9. The curve of the summed excitation force F_{R} of the edge groups is drawn in with dotted lines, the curve of the excitation force F_{M} of the central group with a dashed line, and the curve of the resulting excitation force Fₑᵣᵣ with a solid line. The phase shift 40 of the amplitude of the entire system to the amplitude of the edge groups or to the amplitude of the central group correspond to half the angle of difference [symbol] . This angle of difference is 0° in the upper diagram, 90° in the centre diagram, and 180° in the lower diagram.

The vibration of the entire system results from the superposition of the vibrations of the edge groups and the central group. As the maximum amplitude of the horizontal or vertical excitation force F_{Mmax} of the central group has the same magnitude as the summed excitation force F_{Rmax} of the two edge groups (F_{Rmax}=F_{Mmax}=Fₘₐₓ/2), the reduced (horizontal) excitation force Fₑᵣᵣ can be described as a function of the angle of rotation [symbol] and the angle of difference as follows:

$${F}_{err} = {F}_{Rm ax} \cdot cos ( α ) + {F}_{Mmax} \cdot cos ( α + β ) = \frac{{F}_{m ax}}{2} \cdot cos ( α ) + \frac{{F}_{m ax}}{2} \cdot cos ( α + β )$$

A reduced impact force F_{red} as a function of the maximum impact force Fₘₐₓ (maximum excitation force) is derived from this equation by means of an extreme value analysis and results as a function of the angle of difference between the edge group and the central group:

$${F}_{red} = {F}_{m ax} \cdot cos ( \frac{β}{2} )$$

The reduction factor cos ( [symbol] /2) is shown in FIG. 11, with the maximum impact force Fₘₐₓ (maximum excitation amplitude) occurring at an angle of difference [symbol] of 0°. Specifically, FIG. 11 shows the progression of the reduction factor cos ( [symbol] /2) over the angle of difference [symbol] between 0° and 180°.

A stabilizing unit 11 according to the invention is preferably operated in pairs, as shown in FIG. 1. With two stabilizing units 11 used in series, the variable direction of excitation results in a plurality of possible combinations for ballast compaction: both units 11 in horizontal operation, both units 11 in vertical operation, or one unit 11 in vertical operation and the other unit 11 in horizontal operation.

An advantage of the present invention with regard to the compaction effect lies in the low-lying centre of gravity 22 or in the low-lying plane of action 14 in which the point of application of the horizontal force excitation lies. This enables a predominantly translational excitation of the track panel 4.

Until now, vertical force excitation for compacting the track ballast was only provided in the sleeper cribs and on the shoulders of the ballast superstructure by means of sleeper-crib consolidators and sleeper-end consolidators. The present invention additionally enables vertical excitation of the ballast below each sleeper. Here, it is only important to ensure that the stabilizing unit 11 does not lift off the rail heads in order to avoid damage (head checking, short-pitch corrugation). For safe operation, the vertical imposed load A is set so high by means of the height setting drives 13 that the relieving effect of the centrifugal forces of the vibration generator 12 remains limited.

As the vertical stiffness below the sleeper 5 is greater than in the horizontal direction, there is greater interaction between the rail vehicle 1, the track panel 4, and the ballast bed 3 during vertical operation. The machine parameters must therefore be particularly carefully adjusted to the local conditions in the case of purely vertical excitation, in particular to the condition of the track ballast, the geometry of the ballast bed 3, and the existing subsoil.

An operating mode in which the front of the two stabilizing units 11 is excited vertically and the rear of the two stabilizing units 11 is excited horizontally in one direction of travel simulates travel over the track of a rail vehicle in normal operation. During such travel over the track in normal operation, a preceding lift-off wave usually occurs in front of the rail vehicle (vertical excitation) and a subsequent sinusoidal sway (horizontal excitation). Because this load from the compaction process is thus approximated to later loading from rail traffic, there is a favourable influence on the durability of the preceding track position corrections.

The possibility of compacting the track ballast below the respective sleeper 5 by means of vertical force excitation, in combination with a trailing horizontal excitation, leads to better compaction results. Another major advantage of this operating mode is the compaction control. For this purpose, the vertical force excitation is selected so low that no compaction effect occurs. In this way, statements can be made about the vertical stiffness without disturbing the structure of the ballast and thus the track geometry.

To determine the ballast compaction, acceleration signals are measured on the stabilizing unit 11, as described in AT 521481 A4. As the measured accelerations are force-proportional and the forces from the dynamic excitation are known, the reaction force progression from the track panel 4 can be determined from the difference. To assess the success of compaction, a parameter is subsequently derived from a corresponding work diagram (with constant excitation frequency) or via an impedance function (with variable excitation frequency, dynamic stiffness). An example of a work diagram is shown in FIG. 12. A vibration path 41 of the activated track panel area is shown on the abscissa. The ordinate indicates a contact force 42 below the activated sleepers 5. This work diagram is used to infer the stiffness (relation between defined force difference 43 and measured displacement 44 when loading the track panel 4), the damping of the system (curvature of the curve), and the energy applied 45 (circumscribed area). Dashed horizontal lines indicate a static imposed load 46, a minimum vertical imposed load 47, and a maximum vertical imposed load 48.

A mechanical modelling of the track panel 4 is used as the basis for the compaction control. An optimization process is then used to derive deterministic parameters of the track panel 4, which lead to the measured response for a given excitation with a known power spectral density. A measured variable determined in this way has the advantage that, on the one hand, it can be directly interpreted physically and, on the other hand, also serves as a basis for planning track maintenance.

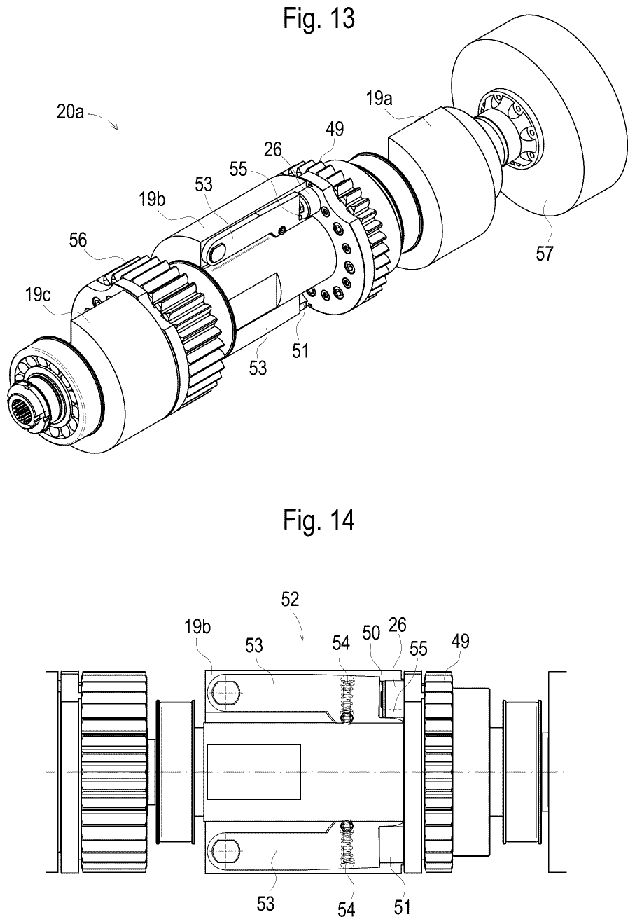

FIG. 13 shows an improved version of the drive shaft 20a with the unbalance masses 19a, 19b, and 19c. The two outer unbalance masses 19a and 19c are permanently connected to the drive shaft 20a. The centre unbalance mass 19a is mounted to rotate on the drive shaft 20a and coupled to a gearwheel 49 via the coupling element 26, which is dependent on the direction of rotation. Here, the position of the centre unbalance mass 19b relative to the gearwheel 49 depends on the direction of rotation. In the position shown, the coupling element 26, which is designed as a reversing pin, lies in an upper driver recess 50 of the unbalance mass 19b. As soon as the direction of rotation of the gearwheel 49 changes, the gearwheel 49 rotates by 180° relative to the unbalance mass 19b until the reversing pin rests in a lower driver recess 51 of the unbalance mass 19b.

A centrifugal-force locking mechanism 52 is arranged to prevent unwanted reversal of the unbalance mass 19b. FIG. 14 shows this detail in a side view. A lever 53 is assigned to both the upper driver recess 50 and the lower driver recess 51. One end of the respective lever 53 is mounted to rotate on the unbalance mass 19b. When at a standstill or when the unbalance mass 19b is at a low rotational speed, the respective lever 53 is pressed inwards by means of an assigned spring 54. In this condition, the driver recesses 50, 51 are free to receive the coupling element 26. As the speed increases, the centrifugal force pushes the two levers 53 outwards. One of the levers 53 engages in a groove 55 of the coupling element 26, which locks the position of the unbalance mass 19b relative to the gearwheel 49. A sensor is usefully arranged to monitor the respective position of the unbalance mass 19b.

In the embodiment variant shown, the unbalance mass 19b is coupled to the two unbalance masses 19d, 19e of the central group and to the gearbox output shaft 35 of the planetary gearbox 30 via the gearwheel 49. An additional gearwheel 56 is arranged on the drive shaft 20a with a further coupling element 26 that is dependent on the direction of rotation. This additional gearwheel 56 rotates by 180° in relation to the drive shaft 20a when the direction of rotation changes and couples the drive shaft 20a with the two auxiliary shafts 20b and with the gearbox input shaft 33 of the planetary gearbox 30. These gearbox elements 30, 49, 56 thus couple all rotating shafts 20a, 20b and unbalance masses 19a-19g, with the drive shaft 20a being connected to a common drive 57.

In order to carry out the method according to the invention, it is useful if the stabilizing units 11 arranged on the rail vehicle 1 are actuated by means of a common control device 58. Here, the control device 58 is set up to separately actuate the vibration generator 12 and the height setting drives 13 of the respective stabilizing unit 11. Preferably, an acceleration sensor 59 arranged on the front stabilizing unit 11 transmits an acceleration signal to the control device 58 in order to subsequently evaluate the reaction force progression of the track panel 4.

1-15. (canceled)

16. A stabilizing unit for stabilizing a track, the stabilizing unit comprising:
a vibration generator having mutually parallel rotating shafts with unbalance masses for generating an impact force in an adjustable direction;
flanged wheels and pressing rollers for transmitting the impact force to a track panel of the track to be stabilized, the track panel consisting of sleepers and rails fixed thereon;
each of said flanged wheels being mounted for rotation about a wheel axis and having a running surface and a wheel diameter;
said rotating shafts being configured to generate the impact force in a horizontal plane of action that lies no more than 300 millimeters above a rolling plane of said flanged wheels.

17. The stabilizing unit according to claim 16, wherein said rotating shafts are disposed so that the horizontal plane of action lies no more than 260 millimeters above the rolling of said flanged wheels defined by the running surface.

18. The stabilizing unit according to claim 16, wherein the horizontal plane of action lies less than one half of a wheel diameter above a horizontal plane passing through a respective wheel axis.

19. The stabilizing unit according to claim 16, wherein at least two said rotating shafts and/or unbalance masses are coupled to gearbox elements and configured to be driven by a common drive.

20. The stabilizing unit according to claim 16, wherein at least one of said unbalance masses is mounted to rotate on each said rotating shaft.

21. The stabilizing unit according to claim 20, which further comprises a coupling element coupling at least one unbalance mass to a respectively assigned rotating shaft, said coupling element being dependent on a direction of rotation and, when the direction of rotation reverses, said unbalance mass is rotated relative to said rotating shaft.

22. The stabilizing unit according to claim 21, wherein, when the direction of rotation reverses, said unbalance mass is rotated relative to said rotating shaft by 180°.

23. The stabilizing unit according to claim 21, wherein said at least one unbalance mass is coupled to the respectively assigned said rotating shaft by way of a centrifugal-force locking mechanism.

24. The stabilizing unit according to claim 16, wherein said rotation shafts include a central rotating shaft extending parallel to a longitudinal direction and a lateral rotating shaft arranged to the left and to the right of said central rotating shaft.

25. The stabilizing unit according to claim 24, wherein said unbalance masses associated with said central rotating shaft have an unbalance that is twice an unbalance of said unbalance masses associated with the respective said lateral rotating shaft.

26. The stabilizing unit according to claim 24, wherein said unbalance masses include directly driven unbalance masses coupled to a common drive, and indirectly driven unbalance masses) coupled to said directly driven unbalance masses via a planetary gearbox.

27. The stabilizing unit according to claim 24, wherein said planetary gearbox has a rotatably mounted cage and said cage is coupled to a rotation drive.

28. The stabilizing unit according to claim 16, which further comprises an acceleration sensor configured to record an acceleration caused by way of said vibration generator.

29. A rail vehicle, comprising:
a machine frame movably supported on rail running gears for moving on a track; and
at least two stabilizing units according to claim 16, including a front stabilizing unit with first height-setting drives fastened to said machine frame and a rear stabilizing unit with second height-setting drives fastened to said machine frame.

30. The rail vehicle according to claim 29, wherein said vibration generators and said height setting drives are actuated by a common control device, and wherein said control device is configured for separate actuation of the respective said vibration generator and the respective said height setting drive.

31. A method for operating a rail vehicle, the method comprising:
providing a rail vehicle with a machine frame that is movably supported on rail running gears, with at least two stabilizing units according to claim 16, including a front stabilizing unit with first height-setting drives fastened to said machine frame and a rear stabilizing unit with second height-setting drives fastened to said machine frame;
moving the rail vehicle forward and thereby operating front stabilizing unit with a vertical impact force and operating the rear stabilizing unit with a horizontal impact force.

32. The method according to claim 31, which comprises recording vertical accelerations at the front stabilizing unit by way of an acceleration sensor in order to derive therefrom a reaction force progression of the track panel.
